(19) United States
(12) Patent Application Publication
(10) Pub. No.: US 2013/0114170 A1
(43) Pub. Date: May 9, 2013

(54) ELECTROSTATIC DISCHARGE PROTECTION APPARATUS

(71) Applicant: Chia-Lung Chen, Tainan City (TW)

(72) Inventor: Chia-Lung Chen, Tainan City (TW)

(73) Assignee: HIMAX TECHNOLOGIES LIMITED, Tainan City (TW)

(21) Appl. No.: 13/292,444

(22) Filed: Nov. 9, 2011

(51) Int. Cl. H02H 9/00

(52) U.S. Cl. 361/56

(57) ABSTRACT

An electrostatic discharge protection apparatus protects an integrated circuit including a first pad and a first internal circuit operating at a power voltage. The electrostatic discharge protection apparatus includes a first protection unit and a control unit. The first protection unit includes a first P-type diode, a first silicon controlled rectifier (SCR), a first resistor and a first buffer. The first P-type diode is electrically connected between a first power line and the first pad. The SCR is electrically connected between the first pad and a first ground line. The first buffer includes an input end electrically connected to the first pad through the first resistor and an output end electrically connected to an input end of the first internal circuit. The control unit generates an isolation signal according to the power voltage to turn off the first SCR.

### BACKGROUND OF THE INVENTION

1. Field of the Invention

The present invention relates to a protection apparatus, and more particularly, to an electrostatic discharge (ESD) protection apparatus.

2. Description of Related Art

In order to avoid damage caused by electrostatic discharge (ESD) events, integrated circuits are usually provided with an ESD protection apparatus. In general, test of the ESD protection apparatus can be classified into four modes including PS, NS, PD and ND modes. In the PS-mode, a positive pulse signal is inputted to the pad and the ground line is grounded. In the NS-mode, a negative pulse signal is inputted to the pad and the ground line is grounded. In the PD-mode, the positive pulse signal is inputted to the pad and the power line is grounded. In the ND-mode, the negative pulse signal is inputted to the pad and the power line is grounded.

Existing ESD protection apparatus mostly include a P-type diode disposed between the power line and the pad, and an N-type diode disposed between the pad and the ground line. The P-type diode mainly conducts the positive pulse signal from the pad to the power line thus providing the PD-mode ESD protection capability, whereas the N-type diode mainly conducts the negative pulse signal from the pad to the ground line thus providing the NS-mode ESD protection capability. In respect of circuit layout, in order for the N-type diode to have the same ESD protection capability as the P-type diode, the layout area of the N-type diode must often be two to three times the layout area of the P-type diode.

In other words, the layout area of the N-type diode must be increased to achieve the necessary ESD protection capability of the N-type diode. This not only causes a large hardware space to be occupied, but also limits the miniaturization of the integrated circuit.

### SUMMARY OF THE INVENTION

Accordingly, the present invention is directed to an electrostatic discharge protection apparatus in which a silicon controlled rectifier is electrically connected between a pad and a ground line to reduce the hardware size of the integrated circuit.

The present invention provides an electrostatic discharge protection apparatus for protecting an integrated circuit. The integrated circuit includes a first pad and a first internal circuit, and the first internal circuit operates at a power voltage. The electrostatic discharge protection apparatus includes a first protection unit and a control unit. The first protection unit includes a first P-type diode, a first silicon controlled rectifier (SCR), a first resistor and a first buffer. The first P-type diode includes a cathode electrically connected to a first power line and an anode electrically connected to the first pad. The first SCR is electrically connected between the first pad and a first ground line. The first resistor includes a first end electrically connected to the first pad. The first buffer includes an input end electrically connected to a second end of the first resistor and an output end electrically connected to the input end of the first internal circuit. The control unit generates an isolation signal according to the power voltage to turn off the first silicon controlled rectifier.

In one embodiment, the integrated circuit further includes a second pad, and the electrostatic discharge protection apparatus further includes a second protection unit. The second protection unit is electrically connected between an output end of the first internal circuit and the second pad, and includes a second buffer, a second P-type diode and a second SCR. The second buffer includes an input end electrically connected to the output end of the first internal circuit and an output end electrically connected to the second pad. The second P-type diode includes a cathode electrically connected to the first power line and an anode electrically connected to the second pad. The second SCR is electrically connected between the second pad and the first ground line. The control unit further utilizes the isolation signal to turn off the second silicon controlled rectifier.

In one embodiment, the electrostatic protection apparatus further includes a first clamp circuit. The first clamp circuit is electrically connected between the first power line and the first ground line. In addition, the first clamp circuit is adapted to conduct electrostatic signals from the second power line and the second ground line.

In view of the forgoing, in the present invention, the SCR is electrically connected between the pad and the ground line and used to achieve the NS-mode ESD protection capability. In addition, the SCR is advantageous in miniaturization, which can reduce the hardware size of the integrated circuit and hence facilitate the miniaturization of the integrated circuit.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 illustrates an electrostatic discharge protection apparatus according to one embodiment of the present invention.

FIG. 2 illustrates the control unit according to one embodiment of the present invention.

### DESCRIPTION OF THE EMBODIMENTS

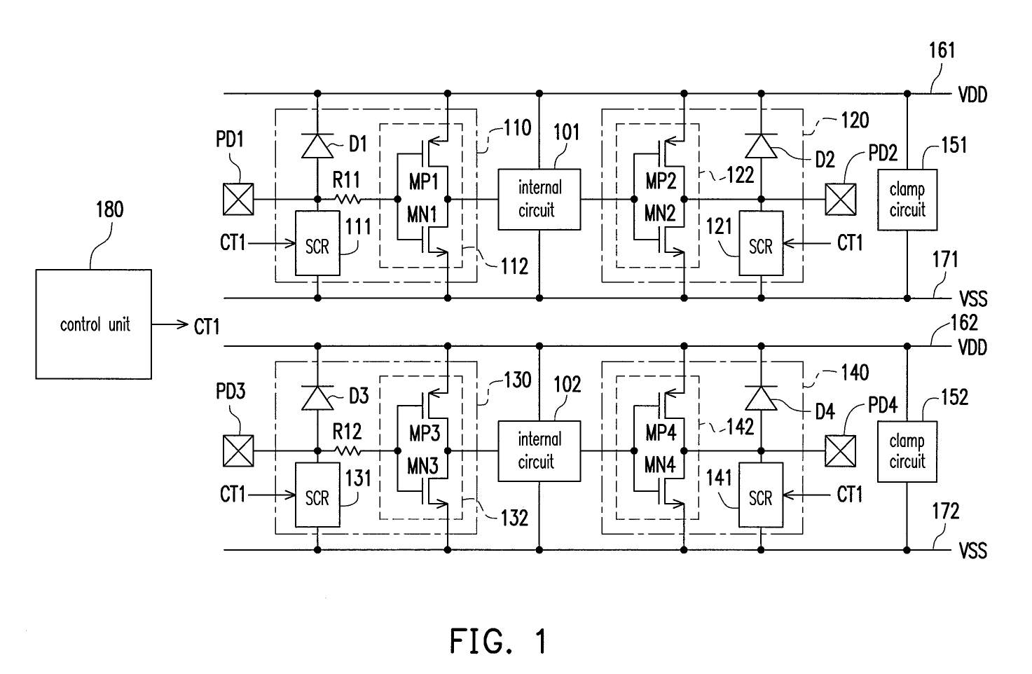

FIG. 1 illustrates an electrostatic discharge (ESD) protection apparatus according to one embodiment of the present invention. Referring to FIG. 1, the ESD protection apparatus is used to protect an integrated circuit comprising an internal circuit 101, an internal circuit 102 and pads PD1 to PD4. In addition, the ESD protection apparatus includes protection units 110 to 140, clamp circuits 151 to 152, and a control unit 180.

In regard to internal circuit 101, the pads PD1 and PD2 act as the input pad and output pad of the internal circuit 101, and the internal circuit 101 is electrically connected between a power line 161 and a ground line 171. In addition, the internal circuit 101 may receive a power voltage VDD through the power line 161 and receive a ground voltage VSS through the ground line 171. As such, when the power voltage VDD is supplied to the integrated circuit, the integrated circuit operates normally and the internal circuit 101 operates at the power voltage VDD.

On the other hand, the protection unit 110 is electrically connected between the pad PD1 and an input end of the internal circuit 101, and includes a P-type diode D1, a silicon controlled rectifier (SCR) 111, a resistor R11, and a buffer 112. In addition, the buffer 112 is composed of a PMOS transistor MP1 and a NMOS transistor MN1. A cathode of the P-type diode D1 is electrically connected to the power line 161 and an anode of the P-type diode D1 is electrically connected to the pad PD1. The SCR 111 is electrically connected between the pad PD1 and the ground line 171. A first end of the resistor R11 is electrically connected to the pad PD1. An input end of the buffer 112 is electrically connected to a second end of the resistor R11, and an output end of the buffer 112 is electrically connected to the input end of the internal circuit 101. In addition, the control unit 180 is electrically connected with the SCR 111.

In overall operation, when the power voltage VDD is supplied to the integrated circuit, the internal circuit 101 operates at the power voltage VDD, and the control unit 180 generates an isolation signal CT1 based on the power voltage VDD. The control unit 180 can utilize the isolation signal CT1 to turn off the SCR 111 thus preventing the SCR 111 from producing a leakage current. On the other hand, when the power voltage VDD is not supplied, the internal circuit 101 and the control unit 180 stop operation. At this time, the internal circuit 101 may be affected by the electrostatic signal from the pad PD 1.

Accordingly, in order to avoid the above situation, when the electrostatic signal from the pad PD1 is a positive pulse signal, the P-type diode D1 and the SCR 111 are turned on respectively, thereby conducting the positive pulse signal to the power line 161 and the ground line 171, respectively. In other words, at this time, the P-type diode D1 and the SCR 111 can provide PD-mode and PS-mode ESD protection capability, respectively. Further, when the electrostatic signal from the pad PD1 is a negative pulse signal, a parasitic inverse diode in the SCR 111 conducts the negative pulse signal to the ground line 171, thus providing an NS-mode ESD protection capability.

Notably, in respect of the circuit layout, the SCR 111 can have the same ESD protection capability as the P-type diode D1 without increasing the layout area of the SCR 111. As such, in comparison with the prior art, achieving the NS-mode ESD protection capability by means of the SCR 111 can reduce the hardwire size of the integrated circuit, thereby facilitating miniaturization of the integrated circuit.

Further, the protection unit 120 is electrically connected between an output end of the internal circuit 101 and the pad PD2, and includes a buffer 122, a P-type diode D2, and a SCR 121. In addition, the buffer 122 is composed of a PMOS transistor MP2 and a NMOS transistor MN2. An input end of the buffer 122 is electrically connected to the output end of the internal circuit 101, and an output end of the buffer 122 is electrically connected to the pad PD2. A cathode of the P-type diode D2 is electrically connected to the power line 161 and an anode of the P-type diode D2 is electrically connected to the pad PD2. The SCR 121 is electrically connected between the pad PD2 and the ground line 171. In addition, the control unit 180 is further electrically connected to the SCR 121.

In overall operation, when the power voltage VDD is supplied to the integrated circuit, the internal circuit 101 operates at the power voltage VDD, and the control unit 180 likewise turns off the SCR 121 by means of the isolation signal CT1. As such, when the internal circuit 101 operates normally, the SCR 121 can be prevented from producing a leakage current. On the other hand, when the power voltage VDD is not supplied, the internal circuit 101 and the control unit 180 stop operation. At this time, similar to the protection circuit 110, the P-type diode D2 and the SCR 121 can conduct a positive pulse signal to the power line 161 and the ground line 171, respectively, and the SCR 121 can further conduct a negative pulse signal to the ground line 171.

All in all, the protection unit 110 and the protection 120 are adapted to prevent the internal circuit 101 from being affected by the electrostatic signals from the input pad (e.g. PD1) and the output pad (e.g. PD2). Similarly, the protection unit 130 and protection unit 140 are adapted to prevent the internal circuit 102 from being affected by the electrostatic signals from the input pad (e.g. PD3) and the output pad (e.g. PD4). Thus, the protection unit 130 has the similar circuit construction as the protection unit 110, and the protection unit 140 has the similar circuit construction as the protection unit 120, in respect of overall operation.

For example, the protection unit 130 is electrically connected between the pad PD3 and an input end of the internal circuit 102, and includes a P-type diode D3, a SCR 131, a resistor R12, and a buffer 132. In addition, the buffer 132 is composed of a PMOS transistor MP3 and a NMOS transistor MN3. In addition, the protection unit 140 is electrically connected between an output end of the internal circuit 102 and the pad PD4, and includes a buffer 142, a P-type diode D4, and a SCR 141. In addition, the buffer 142 is composed of a PMOS transistor MP4 and a NMOS transistor MN4. Here, the connection relationship among internal elements of the protection units 130 and 140 is similar to that with respect to the protection units 110 and 120 and, therefore, is not repeated herein.

In overall operation, the internal circuit 102 receives the power voltage VDD and the ground voltage VSS via the power line 162 and the ground line 172, respectively. As such, when the power voltage VDD is supplied to the integrated circuit, the internal circuit 102 operates at the power voltage VDD, and the control unit 180 likewise turns off the SCR 131 and the SCR 141 by means of the isolation signal CT1. Thus, when the internal circuit 101 operates normally, the SCR 131 and the SCR 141 can be prevented from producing a leakage current.

On the other hand, when the power voltage VDD is not supplied, the internal circuit 102 and the control unit 180 stop operation. At this time, as far as the protection unit 130 is concerned, the P-type diode D3 and the SCR 131 can conduct a positive pulse signal to the power line 162 and the ground line 172, respectively, and the SCR 131 can further conduct a negative pulse signal to the ground line 172. Similarly, as far as the protection unit 140 is concerned, the P-type diode D4 and the SCR 141 can conduct a positive pulse signal to the power line 162 and the ground line 172, respectively, and the SCR 141 can further conduct a negative pulse signal to the ground line 172.

Further, the clamp circuit 151 is electrically connected between the power line 161 and the ground line 171, and the clamp circuit 152 is electrically connected between the power line 162 and the ground line 172. As such, the clamp circuit 151 can conduct the electrostatic signals from the power line 161 and the ground line 171, and the clamp circuit 152 can conduct the electrostatic signals from the power line 162 and the ground line 172. Therefore, the protection capability of the ESD protection apparatus can be further enhanced.

Notably, the protection units 110 to 140 share the control unit 180 to turn off the SCRs 111, 121, 131 and 141 using the same isolation signal CT1. In order to enable people skilled in the art to better understand the present invention, an implementation of the control unit 180 is explained below by way of example.

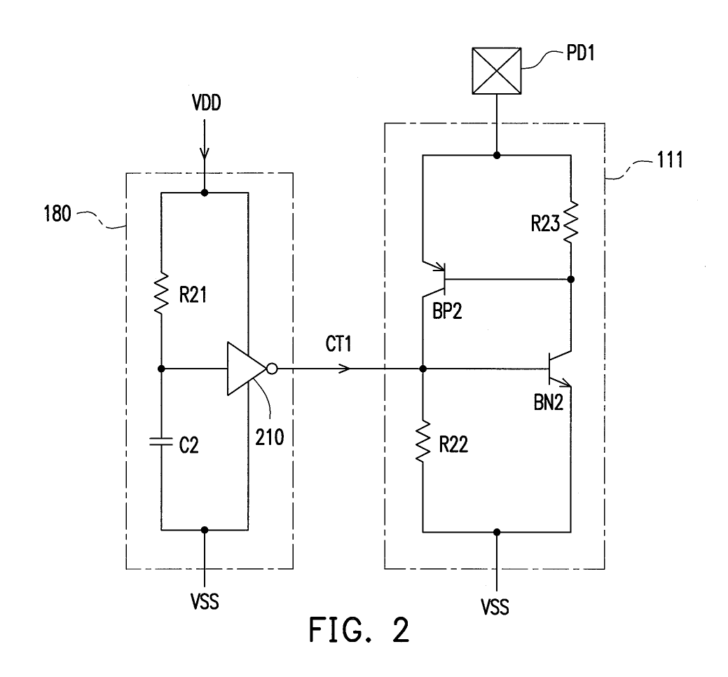

FIG. 2 illustrates the control unit according to one embodiment of the present invention. For easy description, FIG. 2 further illustrates the pad PD1 and SCR 111. Here, the equivalent circuit of the SCR 111 includes a PNP transistor BP2, a NPN transistor BN2, and resistors R22 and R23. In addition, as shown in FIG. 2, the control unit 180 includes a resistor R21, a capacitor C2, and an inverter 210.

Referring to FIG. 2, a first end of the resistor R21 receives the power voltage VDD. A first end of the capacitor C2 is electrically connected to a second end of the resistor R21, and a second end of the capacitor C2 receives the ground voltage VSS. In addition, the inverter 210 operates at the power voltage VDD. Further, an input end of the inverter 210 is electrically connected to the second end of the resistor R21, and an output end of the inverter 210 is electrically connected to the SCRs 111, 121, 131, and 141. In operation, when the power voltage VDD is supplied to the integrated circuit, the power voltage VDD can charge the capacitor C2 through the resistor R21. At this time, the inverter 210 can receive a high level signal and, based on the high level signal, generate a low level signal as the isolation signal CT1. Therefore, taking the SCR 111 as an example, the base of the NPN transistor BN2 receives the isolation signal CT1 with low level to turn off the SCR 111.

In summary, in the present invention, the SCR is electrically connected between the pad and the ground line and used to achieve the NS-mode ESD protection capability. In addition, the SCR is advantageous in miniaturization, which can reduce the hardware size of the integrated circuit and hence facilitate the miniaturization of the integrated circuit.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrostatic discharge protection apparatus for protecting an integrated circuit, the integrated circuit comprising a first pad and a first internal circuit, the first internal circuit operating at a power voltage, the electrostatic discharge protection apparatus comprising:
a first protection unit electrically connected between the first pad and an input end of the first internal circuit, and comprising:
a first P-type diode comprising a cathode electrically connected to a first power line and an anode electrically connected to the first pad;
a first silicon controlled rectifier electrically connected between the first pad and a first ground line;
a first resistor comprising a first end electrically connected to the first pad; and
a first buffer comprising an input end electrically connected to a second end of the first resistor and an output end electrically connected to the input end of the first internal circuit; and
a control unit adapted to generate an isolation signal according to the power voltage to turn off the first silicon controlled rectifier.

2. The electrostatic discharge protection apparatus according to claim 1, wherein the integrated circuit further comprises a second pad, and the electrostatic discharge protection apparatus further comprises:
a second protection unit electrically connected between an output end of the first internal circuit and the second pad, and the second protection unit comprising:
a second buffer comprising an input end electrically connected to the output end of the first internal circuit and an output end electrically connected to the second pad;
a second P-type diode comprising a cathode electrically connected to the first power line and an anode electrically connected to the second pad; and
a second silicon controlled rectifier electrically connected between the second pad and the first ground line, wherein the control unit further utilizes the isolation signal to turn off the second silicon controlled rectifier.

3. The electrostatic discharge protection apparatus according to claim 1, further comprising a first clamp circuit electrically connected between the first power line and the first ground line and adapted to conduct electrostatic signals from the first power line and the first ground line.

4. The electrostatic discharge protection apparatus according to claim 1, wherein the integrated circuit further comprises a third pad and a second internal circuit, the second internal circuit operating at the power voltage, and the electrostatic discharge protection apparatus further comprises:
a third protection unit electrically connected between the third pad and an input end of the second internal circuit, and the third protection unit comprising:
a third P-type diode comprising a cathode electrically connected to a second power line and an anode electrically connected to the third pad;
a third silicon controlled rectifier electrically connected between the third pad and a second ground line, wherein the control unit further utilizes the isolation signal to turn off the third silicon controlled rectifier;
a second resistor comprising a first end electrically connected to the third pad; and
a third buffer comprising an input end electrically connected to a second end of the second resistor and an output end electrically connected to the input end of the second internal circuit.

5. The electrostatic discharge protection apparatus according to claim 4, wherein the integrated circuit further comprises a fourth pad, and the electrostatic discharge protection apparatus further comprises:
a fourth protection unit electrically connected between an output end of the second internal circuit and the fourth pad, and the fourth protection unit comprising:
a fourth buffer comprising an input end electrically connected to the output end of the second internal circuit and an output end electrically connected to the fourth pad;
a fourth P-type diode comprising a cathode electrically connected to the second power line and an anode electrically connected to the fourth pad; and
a fourth silicon controlled rectifier electrically connected between the fourth pad and the second ground line, wherein the control unit further utilizes the isolation signal to turn off the fourth silicon controlled rectifier.

6. The electrostatic discharge protection apparatus according to claim 4, further comprising a second clamp circuit electrically connected between the second power line and the second ground line and adapted to conduct electrostatic signals from the second power line and the second ground line.

7. The electrostatic discharge protection apparatus according to claim 1, wherein the control unit comprises:
a third resistor comprising a first end for receiving the power voltage;
a capacitor comprising a first end electrically connected to a second end of the third resistor and a second end for receiving a ground voltage; and
an inverter operating at the power voltage, wherein the inverter comprises an input end electrically connected the second end of the third resistor and an output end adapted for generating the isolation signal.
